(19) United States
(12) Patent Application Publication
(10) Pub. No.: US 2023/0236910 A1
(43) Pub. Date: Jul. 27, 2023

(54) Systems and Methods for Executing Robotic Process Automation (RPA) Within a Web Browser

(71) Applicant: UiPath Inc., New York, NY (US)

(72) Inventor: Razvan MARINOVICI, Bucuresti (RO)

(21) Appl. No.: 17/648,717

(22) Filed: Jan. 24, 2022

Related U.S. Application Data
(63) Continuation of application No. 17/648,713, filed on Jan. 24, 2022.

(51) Int. Cl. H04L 67/12; G06F 3/14; G06F 3/04842; G06F 40/14; H04L 67/02; G06F 9/451

(52) U.S. Cl. CPC H04L 67/12; G06F 3/14; G06F 3/04842; G06F 40/14; H04L 67/02; G06F 9/452; G06F 2203/04803

(57) ABSTRACT

In some embodiments, a robotic process automation (RPA) agent executing within a first browser window/tab interacts with an RPA driver injected into a target web page displayed within a second browser window/tab. A bridge module establishes a communication channel between the RPA agent and the RPA driver. In one exemplary use case, the RPA agent receives a robot specification from a remote server, the specification indicating at least one RPA activity, and communicates details of the respective activity to the RPA driver via the communication channel. The RPA driver identifies a runtime target for the RPA activity within the target web page and executes the respective activity.

### RELATED APPLICATIONS

This application is a continuation of U.S. patent application Ser. No. 17/648,713 filed on Jan. 24, 2022, entitled “Browser-Based Robotic Process Automation (RPA) Robot Design Interface,” which is herein incorporated by reference.

### BACKGROUND

The invention relates to robotic process automation (RPA) and in particular to carrying out RPA activities within a web browser.

RPA is an emerging field of information technology aimed at improving productivity by automating repetitive computing tasks, thus freeing human operators to perform more intellectually sophisticated and/or creative activities. Notable tasks targeted for automation include extracting structured data from documents (e.g., invoices, webpages) and interacting with user interfaces, for instance to fill in forms, send email, and post messages to social media sites, among others.

A distinct drive in RPA development is directed at extending the reach of RPA technology to a broad audience of developers and industries spanning multiple hardware and software platforms.

### SUMMARY

According to one aspect, a method comprises employing at least one hardware processor of a computer system to execute a first web browser process, a second web browser process, and a bridge module. The bridge module is configured to set up a communication channel between the first web browser process and the second web browser process. The first web browser process exposes to a user a first web browser window. The first web browser process is further configured to receive a specification of an RPA workflow from a remote server computer, to select an RPA activity for execution from the RPA workflow, the RPA activity comprising mimicking an action of the user on a target element of a target web page displayed within a second browser window, and to transmit a set of target identification data characterizing the target element via the communication channel. The second web browser process executes an RPA driver configured to receive the set of target identification data via the communication channel; in response, to identify the target element within the target web page according to the target identification data, and to carry out the RPA activity.

According to another aspect, a computer system comprises at least one hardware processor configured to execute a first web browser process, a second web browser process, and a bridge module. The bridge module is configured to set up a communication channel between the first web browser process and the second web browser process. The first web browser process exposes to a user a first web browser window. The first web browser process is further configured to receive a specification of an RPA workflow from a remote server computer, to select an RPA activity for execution from the RPA workflow, the RPA activity comprising mimicking an action of the user on a target element of a target web page displayed within a second browser window, and to transmit a set of target identification data characterizing the target element via the communication channel. The second web browser process executes an RPA driver configured to receive the set of target identification data via the communication channel; in response, to identify the target element within the target web page according to the target identification data, and to carry out the RPA activity.

According to another aspect, a non-transitory computer-readable medium stores instructions which, when executed by at least one hardware processor of a computer system, cause the computer system to form a bridge module configured to set up a communication channel between a first web browser process and a second web browser process, wherein the first and second web browser processes execute on the computer system. The bridge module is configured to set up a communication channel between the first web browser process and the second web browser process. The first web browser process exposes to a user a first web browser window. The first web browser process is further configured to receive a specification of an RPA workflow from a remote server computer, to select an RPA activity for execution from the RPA workflow, the RPA activity comprising mimicking an action of the user on a target element of a target web page displayed within a second browser window, and to transmit a set of target identification data characterizing the target element via the communication channel. The second web browser process executes an RPA driver configured to receive the set of target identification data via the communication channel; in response, to identify the target element within the target web page according to the target identification data, and to carry out the RPA activity.

### BRIEF DESCRIPTION OF THE DRAWINGS

The foregoing aspects and advantages of the present invention will become better understood upon reading the following detailed description and upon reference to the drawings where:

FIG. 1 shows an exemplary robotic process automation (RPA) environment according to some embodiments of the present invention.

FIG. 2 illustrates exemplary components and operation of an RPA robot and orchestrator according to some embodiments of the present invention.

FIG. 3 illustrates exemplary components of an RPA package according to some embodiments of the present invention.

FIG. 4 shows a variety of RPA host systems according to some embodiments of the present invention.

FIG. 5 shows exemplary software components executing on an RPA host system according to some embodiments of the present invention.

FIG. 6-A illustrates an exemplary configuration for carrying out RPA activities within a browser according to some embodiments of the present invention.

FIG. 6-B shows another exemplary configuration for carrying out RPA activities within a browser according to some embodiments of the present invention.

FIG. 7 shows an exemplary robot design interface exposed by an agent browser window according to some embodiments of the present invention.

FIG. 8 shows an exemplary activity configuration interface according to some embodiments of the present invention.

FIG. 9 shows an exemplary target webpage exposed within a target browser window, and a set of target identification data according to some embodiments of the present invention.

FIG. 10 shows an exemplary target configuration interface according to some embodiments of the present invention.

FIG. 11 illustrates an exemplary sequence of steps carried out by a bridge module according to some embodiments of the present invention.

FIG. 12 shows an exemplary sequence of steps performed by an RPA agent according to some embodiments of the present invention.

FIG. 13 shows an exemplary sequence of steps performed by an RPA driver according to some embodiments of the present invention.

FIG. 14 shows exemplary target and anchor highlighting according to some embodiments of the present invention.

FIG. 15 shows another exemplary sequence of steps performed by a bridge module according to some embodiments of the present invention.

FIG. 16 shows another exemplary sequence of steps performed by an RPA agent according to some embodiments of the present invention.

FIG. 17 shows another exemplary sequence of steps performed by an RPA driver according to some embodiments of the present invention.

FIG. 18 shows an exemplary hardware configuration of a computer system programmed to execute some of the methods described herein.

### DETAILED DESCRIPTION OF PREFERRED EMBODIMENTS

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Any use of ‘or’ is meant as a nonexclusive or. Unless otherwise required, any described method steps need not be necessarily performed in a particular illustrated order. A first element (e.g. data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. A computer program is a sequence of processor instructions carrying out a task. Computer programs described in some embodiments of the present invention may be stand-alone software entities or sub-entities (e.g., subroutines, libraries) of other computer programs. A process is an instance of a computer program, the instance characterized by having at least an execution thread and a separate virtual memory space assigned to it, wherein a content of the respective virtual memory space includes executable code. The term ‘database’ is used herein to denote any organized, searchable collection of data. Computer-readable media encompass non-transitory media such as magnetic, optic, and semiconductor storage media (e.g., hard drives, optical disks, flash memory, DRAM), as well as communication links such as conductive cables and fiber optic links. According to some embodiments, the present invention provides, inter alia, computer systems comprising hardware (e.g., one or more processors) programmed to perform the methods described herein, as well as computer-readable media encoding instructions to perform the methods described herein.

The following description illustrates embodiments of the invention by way of example and not necessarily by way of limitation.

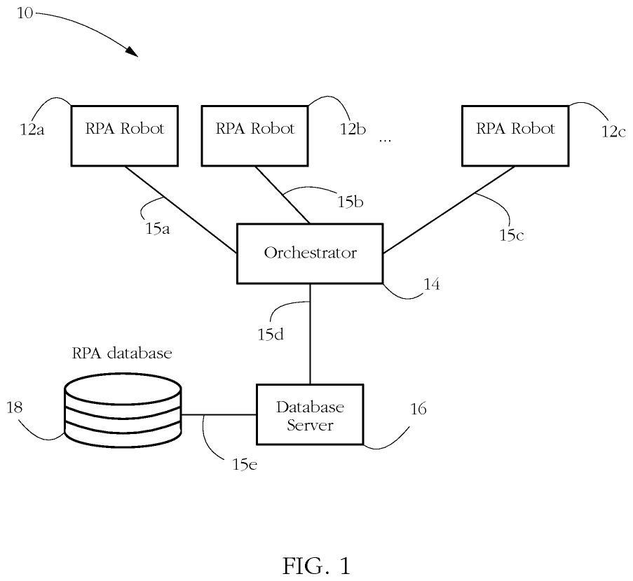

FIG. 1 shows an exemplary robotic process automation (RPA) environment 10 according to some embodiments of the present invention. Environment 10 comprises various software components which collaborate to achieve the automation of a particular task. In an exemplary RPA scenario, an employee of a company uses a business application (e.g., word processor, spreadsheet editor, browser, email application) to perform a repetitive task, for instance to issue invoices to various clients. To actually carry out the respective task, the employee performs a sequence of operations/actions, such as opening a Microsoft Excel® spreadsheet, looking up company details of a client, copying the respective details into an invoice template, filling out invoice fields indicating the purchased items, switching over to an email application, composing an email message to the respective client, attaching the newly created invoice to the respective email message, and clicking a ‘Send’ button. Various elements of RPA environment 10 may automate the respective process by mimicking the set of operations performed by the respective human operator in the course of carrying out the respective task.

Mimicking a human operation/action is herein understood to encompass reproducing the sequence of computing events that occur when a human operator performs the respective operation/action on the computer, as well as reproducing a result of the human operator's performing the respective operation on the computer. For instance, mimicking an action of clicking a button of a graphical user interface (GUI) may comprise having the operating system move the mouse pointer to the respective button and generating a mouse click event, or may alternatively comprise toggling the respective GUI button itself to a clicked state.

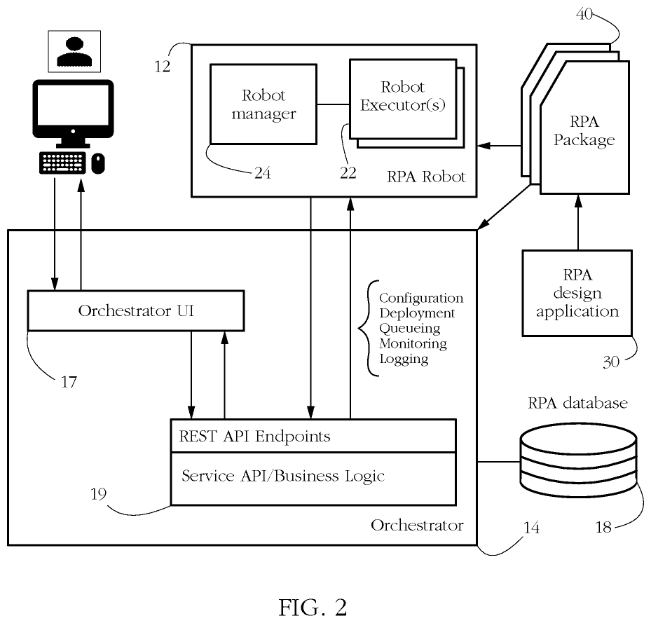

Activities typically targeted for RPA automation include processing of payments, invoicing, communicating with business clients (e.g., distribution of newsletters and/or product offerings), internal communication (e.g., memos, scheduling of meetings and/or tasks), auditing, and payroll processing, among others. In some embodiments, a dedicated RPA design application 30 (FIG. 2) enables a human developer to design a software robot to implement a workflow that effectively automates a sequence of human actions. A workflow herein denotes a sequence of custom automation steps, herein deemed RPA activities. Each RPA activity includes at least one action performed by the robot, such as clicking a button, reading a file, writing to a spreadsheet cell, etc. Activities may be nested and/or embedded. In some embodiments, RPA design application 30 exposes a user interface and set of tools that give the developer control of the execution order and the relationship between RPA activities of a workflow. One commercial example of an embodiment of RPA design application 30 is UiPath StudioX®. In some embodiments of the present invention, at least a part of RPA design application 30 may execute within a browser, as described in detail below.

Some types of workflows may include, but are not limited to, sequences, flowcharts, finite state machines (FSMs), and/or global exception handlers. Sequences may be particularly suitable for linear processes, enabling flow from one activity to another without cluttering a workflow. Flowcharts may be particularly suitable to more complex business logic, enabling integration of decisions and connection of activities in a more diverse manner through multiple branching logic operators. FSMs may be particularly suitable for large workflows. FSMs may use a finite number of states in their execution, which are triggered by a condition (i.e., transition) or an activity. Global exception handlers may be particularly suitable for determining workflow behavior when encountering an execution error and for debugging processes.

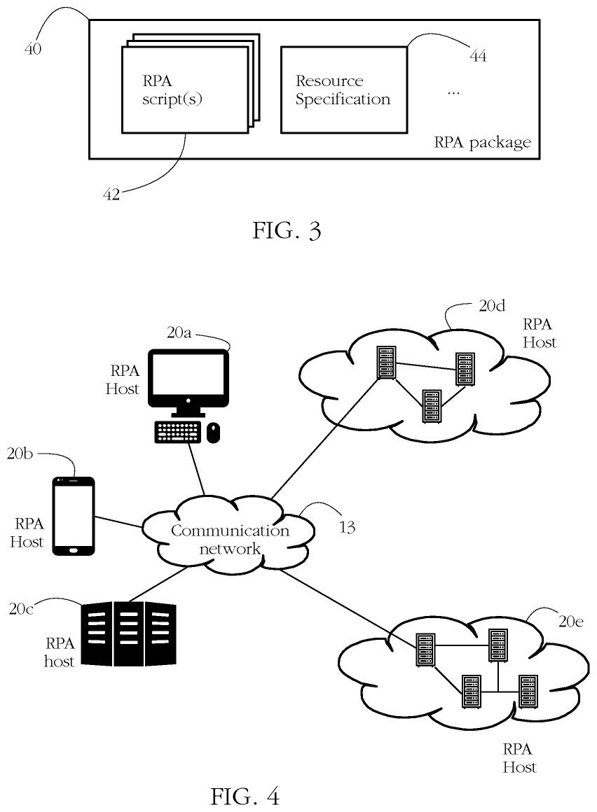

Once an RPA workflow is developed, it may be encoded in computer-readable form and exported as an RPA package 40 (FIG. 2). In some embodiments as illustrated in FIG. 3, RPA package 40 includes a set of RPA scripts 42 comprising set of instructions for a software robot. RPA script(s) 42 may be formulated according to any data specification known in the art, for instance in a version of an extensible markup language (XML), JavaScript® Object Notation (JSON), or a programming language such as C#, Visual Basic®, Java®, JavaScript®, etc. Alternatively, RPA script(s) 42 may be formulated in an RPA-specific version of bytecode, or even as a sequence of instructions formulated in a natural language such as English, Spanish, Japanese, etc. In some embodiments, RPA scripts(s) 42 are pre-compiled into a set of native processor instructions (e.g., machine code).

In some embodiments, RPA package 40 further comprises a resource specification 44 indicative of a set of process resources used by the respective robot during execution. Exemplary process resources include a set of credentials, a computer file, a queue, a database, and a network connection/communication link, among others. Credentials herein generically denote private data (e.g., username, password) required for accessing a specific RPA host machine and/or for executing a specific software component. Credentials may comprise encrypted data; in such situations, the executing robot may possess a cryptographic key for decrypting the respective data. In some embodiments, credential resources may take the form of a computer file. Alternatively, an exemplary credential resource may comprise a lookup key (e.g., hash index) into a database holding the actual credentials. Such a database is sometimes known in the art as a credential vault. A queue herein denotes a container holding an ordered collection of items of the same type (e.g., computer files, structured data objects). Exemplary queues include a collection of invoices and the contents of an email inbox, among others. The ordering of queue items may indicate an order in which the respective items should be processed by the executing robot.

In some embodiments, for each process resource, specification 44 comprises a set of metadata characterizing the respective resource. Exemplary resource characteristics/metadata include, among others, an indicator of a resource type of the respective resource, a filename, a filesystem path and/or other location indicator for accessing the respective resource, a size, and a version indicator of the respective resource. Resource specification 44 may be formulated according to any data format known in the art, for instance as an XML, or JSON script, a relational database, etc.

A skilled artisan will appreciate that RPA design application 30 may comprise multiple components/modules, which may execute on distinct physical machines. In one example, RPA design application 30 may execute in a client-server configuration, wherein one component of application 30 may expose a robot design interface to a user of a client computer, and another component of application 30 executing on a server computer may assemble the robot workflow and formulate/output RPA package 40. For instance, a developer may access the robot design interface via a web browser executing on the client computer, while the software formulating package 40 actually executes on the server computer.

Once formulated, RPA script(s) 42 may be executed by a set of robots 12a-c (FIG. 1), which may be further controlled and coordinated by an orchestrator 14. Robots 12a-c and orchestrator 14 may each comprise a plurality of computer programs, which may or may not execute on the same physical machine. Exemplary commercial embodiments of robots 12a-c and orchestrator 14 include UiPath Robots® and UiPath Orchestrator®, respectively. In some embodiments of the present invention, at least a part of an RPA robot may execute within a browser, as described in detail below.

Types of robots 12a-c include, but are not limited to, attended robots, unattended robots, development robots (similar to unattended robots, but used for development and testing purposes), and nonproduction robots (similar to attended robots, but used for development and testing purposes).

Attended robots are triggered by user events and/or commands and operate alongside a human operator on the same computing system. In some embodiments, attended robots can only be started from a robot tray or from a command prompt and thus cannot be controlled from orchestrator 14 and cannot run under a locked screen, for example. Unattended robots may run unattended in remote virtual environments and may be responsible for remote execution, monitoring, scheduling, and providing support for work queues.

Orchestrator 14 controls and coordinates the execution of multiple robots 12a-c. As such, orchestrator 14 may have various capabilities including, but not limited to, provisioning, deployment, configuration, scheduling, queueing, monitoring, logging, and/or providing interconnectivity for robots 12a-c. Provisioning may include creating and maintaining connections between robots 12a-c and orchestrator 14. Deployment may include ensuring the correct delivery of software (e.g, RPA scripts 42) to robots 12a-c for execution. Configuration may include maintenance and delivery of robot environments, resources, and workflow configurations. Scheduling may comprise configuring robots 12a-c to execute various tasks according to specific schedules (e.g., at specific times of the day, on specific dates, daily, etc.). Queueing may include providing management of job queues. Monitoring may include keeping track of robot state and maintaining user permissions. Logging may include storing and indexing logs to a database and/or another storage mechanism (e.g., SQL, ElasticSearch®, Redis®). Orchestrator 14 may further act as a centralized point of communication for third-party solutions and/or applications.

FIG. 2 shows exemplary components of a robot 12 and orchestrator 14 according to some embodiments of the present invention. An exemplary RPA robot 12 is constructed using a Windows® Workflow Foundation Application Programming Interface from Microsoft, Inc. Robot 12 may comprise a set of robot executors 22 and a robot manager 24. Robot executors 22 are configured to receive RPA script(s) 42 indicating a sequence of RPA activities that mimic the actions of a human operator, and to automatically perform the respective sequence of activities on the respective client machine. In some embodiments, robot executor(s) 22 comprise an interpreter (e.g., a just-in-time interpreter or compiler) configured to translate RPA script(s) 42 into a runtime object comprising processor instructions for carrying out the RPA activities encoded in the respective script(s). Executing script(s) 42 may thus comprise executor(s) 22 translating RPA script(s) 42 and instructing a processor of the respective host machine to load the resulting runtime package into memory and to launch the runtime package into execution.

Robot manager 24 may manage the operation of robot executor(s) 22. For instance, robot manager 24 may select tasks/scripts for execution by robot executor(s) 22 according to an input from a human operator and/or according to a schedule. Manager 24 may start and stop jobs and configure various operational parameters of executor(s) 22. When robot 12 includes multiple executors 22, manager 24 may coordinate their activities and/or inter-process communication. Manager 24 may further manage communication between RPA robot 12, orchestrator 14 and/or other entities.

In some embodiments, robot 12 and orchestrator 14 may execute in a client-server configuration. It should be noted that the client side, the server side, or both, may include any desired number of computing systems (e.g., physical or virtual machines) without deviating from the scope of the invention. In such configurations, robot 12 including executor(s) 22 and robot manager 24 may execute on a client side. Robot 12 may run several jobs/workflows concurrently. Robot manager 24 (e.g., a Windows® service) may act as a single client-side point of contact of multiple executors 22. Manager 24 may further manage communication between robot 12 and orchestrator 14. In some embodiments, communication is initiated by manager 24, which may open a WebSocket channel to orchestrator 14. Manager 24 may subsequently use the channel to transmit notifications regarding the state of each executor 22 to orchestrator 14, for instance as a heartbeat signal. In turn, orchestrator 14 may use the channel to transmit acknowledgements, job requests, and other data such as RPA script(s) 42 and resource metadata to robot 12.

Orchestrator 14 may execute on a server side, possibly distributed over multiple physical and/or virtual machines. In one such embodiment, orchestrator 14 may include an orchestrator user interface (UI) 17 which may be a web application, and a set of service modules 19. Several examples of an orchestrator UI are discussed below. Service modules 19 may include a set of Open Data Protocol (OData) Representational State Transfer (REST) Application Programming Interface (API) endpoints, and a set of service APIs/business logic. A user may interact with orchestrator 14 via orchestrator UI 17 (e.g., by opening a dedicated orchestrator interface on a browser), to instruct orchestrator 14 to carry out various actions, which may include for instance starting jobs on a selected robot 12, creating robot groups/pools, assigning workflows to robots, adding/removing data to/from queues, scheduling jobs to run unattended, analyzing logs per robot or workflow, etc. Orchestrator UI 17 may be implemented using Hypertext Markup Language (HTML), JavaScript®, or any other web technology.

Orchestrator 14 may carry out actions requested by the user by selectively calling service APIs/business logic. In addition, orchestrator 14 may use the REST API endpoints to communicate with robot 12. The REST API may include configuration, logging, monitoring, and queueing functionality. The configuration endpoints may be used to define and/or configure users, robots, permissions, credentials and/or other process resources, etc. Logging REST endpoints may be used to log different information, such as errors, explicit messages sent by the robots, and other environment-specific information, for instance. Deployment REST endpoints may be used by robots to query the version of RPA script(s) 42 to be executed. Queueing REST endpoints may be responsible for queues and queue item management, such as adding data to a queue, obtaining a transaction from the queue, setting the status of a transaction, etc. Monitoring REST endpoints may monitor the web application component of orchestrator 14 and robot manager 24.

In some embodiments, RPA environment 10 (FIG. 1) further comprises a database server 16 connected to an RPA database 18. In an embodiment wherein server 16 is provisioned on a cloud computing platform, server 16 may be embodied as a database service, e.g., as a client having a set of database connectors. Database server 16 is configured to selectively store and/or retrieve data related to RPA environment 10 in/from database 18. Such data may include configuration parameters of various individual robots or robot pools, as well as data characterizing workflows executed by various robots, data associating workflows with the robots tasked with executing them, data characterizing users, roles, schedules, queues, etc. Another exemplary category of data stored and/or retrieved by database server 16 includes data characterizing the current state of each executing robot. Another exemplary data category stored and/or retrieved by database server 16 includes RPA resource metadata characterizing RPA resources required by various workflows, for instance default and/or runtime values of various resource attributes such as filenames, locations, credentials, etc. Yet another exemplary category of data includes messages logged by various robots during execution. Database server 16 and database 18 may employ any data storage protocol and format known in the art, such as structured query language (SQL), ElasticSearch®, and Redis®, among others. In some embodiments, data is gathered and managed by orchestrator 14, for instance via logging REST endpoints. Orchestrator 14 may further issue structured queries to database server 16.

In some embodiments, RPA environment 10 (FIG. 1) further comprises communication channels/links 15a-e interconnecting various members of environment 10. Such links may be implemented according to any method known in the art, for instance as virtual network links, virtual private networks (VPN), or end-to-end tunnels. Some embodiments further encrypt data circulating over some or all of links 15a-e.

A skilled artisan will understand that various components of RPA environment 10 may be implemented and/or may execute on distinct host computer systems (physical appliances and/or virtual machines). FIG. 4 shows a variety of such RPA host systems 20a-e according to some embodiments of the present invention. Each host system 20a-e represents a computing system (an individual computing appliance or a set of interconnected computers) having at least a hardware processor and a memory unit for storing processor instructions and/or data. Exemplary RPA hosts 20a-c include corporate mainframe computers, personal computers, laptop and tablet computers, mobile telecommunication devices (e.g., smartphones), and e-book readers, among others. Other exemplary RPA hosts illustrated as items 20d-e include a cloud computing platform comprising a plurality of interconnected server computer systems centrally-managed according to a platform-specific protocol. Clients may interact with such cloud computing platforms using platform-specific interfaces/software layers/libraries (e.g., software development kits—SDKs, plugins, etc.) and/or a platform-specific syntax of commands. Exemplary platform-specific interfaces include the Azure® SDK and AWS® SDK, among others. RPA hosts 20a-e may be communicatively coupled by a communication network 13, such as the Internet.

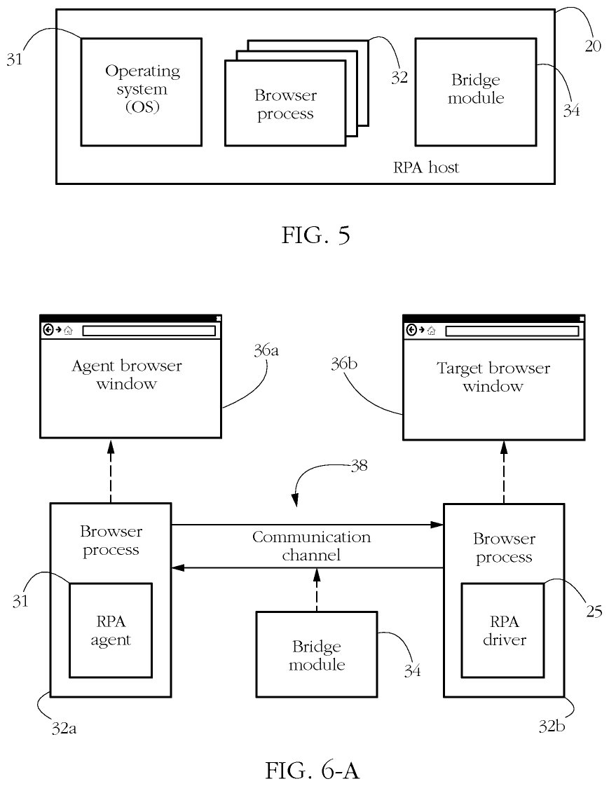

FIG. 5 shows exemplary software executing on an RPA host 20 according to some embodiments of the present invention, wherein host 20 may represent any of RPA hosts 20a-e in FIG. 4. Operating system (OS) 31 may comprise any widely available operating system such as Microsoft Windows®, MacOS®, Linux®, iOS®, or Android®, among others, comprising a software layer that interfaces between the hardware of RPA host 20 and other software applications such as a set of web browser processes 32 and a bridge module 34, among others. Web browser processes 32 herein denote any software whose primary purpose is to fetch and render web content (web pages). Exemplary web browser processes include any instance of a commercial web browser, such as Google Chrome®, Microsoft Edge®, and Mozilla Firefox®, among others. Modern web browsers typically allow displaying multiple web documents concurrently, for instance in separate windows or browser tabs. For computer security reasons, in some such applications, each distinct browser window, tab, and/or frame may be rendered by a distinct web browser process isolated from other web browser processes executing on the respective host. Software isolation herein refers to each browser process having its own distinct memory space, e.g., its own local variables/arguments. Isolation further ensures that each browser process is oblivious of any content displayed in other browser windows except its own. Isolation herein encompasses isolation enforced by a local OS and isolation enforced by the web browser application itself independently of the OS.

In some embodiments, RPA host 20 executes a bridge module 34 configured to establish a communication channel between at least two distinct browser processes 32. A communication channel herein denotes any means of transferring data between the respective browser processes. A skilled artisan will know that there may be many ways of establishing such inter-process communication, for instance by mapping a region of a virtual memory of each browser process (e.g., a page of virtual memory) to the same region of physical memory (e.g., a physical memory page), so that the respective browser processes can exchange data by writing to and/or reading the respective data from the respective memory page. Other exemplary inter-process communication means which may be used by bridge module 34 include a socket (i.e., transferring data via a network interface of RPA host 20), a pipe, a file, and message passing, among others. In some embodiments of the present invention, bridge module 34 comprises a browser extension computer program as further described below. The term ‘browser extension’ herein denotes an add-on, custom computer program that extends the native functionality of a browser application, and that executes within the respective browser application (i.e., uses a browser process for execution).

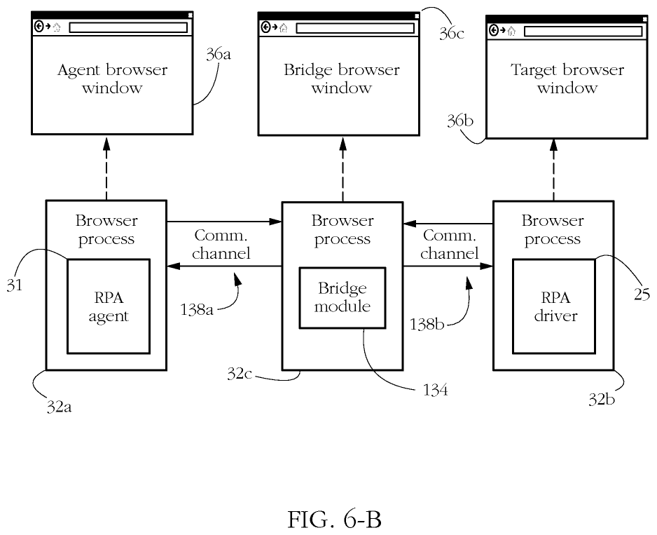

FIGS. 6-A-B illustrate exemplary ways of carrying out RPA activities in a browser according to some embodiments of the present invention. In the exemplary configuration of FIG. 6-A, a first browser process 32a exposes an agent browser window 36a, while a second browser process 32 exposes a target browser window 36b. In one such example, browser windows 36a-b represent distinct browser tabs opened by an instance of a commercial web browser application such as Google Chrome®. In some embodiments, agent browser window 36a displays an RPA interface enabling a user to carry out an automation task, such as designing an RPA robot or executing an RPA robot, among others. Such use cases will be explored separately below. Some embodiments employ target browser window 36b to fetch and display a web document comprising a target/operand of the respective RPA task, e.g., a button to be automatically clicked, a form to be automatically filled in, a piece of text or an image to be automatically grabbed, etc.

Some modern browsers enable the rendering of web documents which include snippets of executable code. The respective executable code may control how the content of the respective document is displayed to a user, manage the distribution and display of third-party content (e.g., advertising, weather, stock market updates), gather various kinds of data characterizing the browsing habits of the respective user, etc. Such executable code may be embedded in or hyperlinked from the respective document. Exemplary browser-executable code may be pre-compiled or formulated in a scripting language or bytecode for runtime interpretation or compilation. Exemplary scripting languages include JavaScript® and VBScript®, among others. To enable code execution, some browsers include an interpreter configured to translate the received code from a scripting language/bytecode into a form suitable for execution on the respective host platform, and provide a hosting environment for the respective code to run in.

Some embodiments of the present invention use browser process 32a and agent browser window 36a to load a web document comprising an executable RPA agent 31, for instance formulated in JavaScript®. In various embodiments, RPA agent 31 may implement some of the functionality of RPA design application 30 and/or some of the functionality of RPA robot 12, as shown in detail below. RPA agent 31 may be fetched from a remote repository/server, for instance by pointing browser process 32a to a pre-determined uniform resource locator (URL) indicating an address of agent 31. In response to fetching RPA agent 31, browser process 32a may interpret and execute agent 31 within an isolated environment specific to process 32a and/or agent browser window 36a.

Some embodiments further provide an RPA driver 25 to browser process 32b and/or target window 36b. Driver 25 generically represents a set of software modules that carry low-level processing tasks such as constructing, parsing, and/or modifying a document object model (DOM) of a document currently displayed within target browser window 36b, identifying an element of the respective document (e.g., a button, a form field), changing the on-screen appearance of an element (e.g., color, position, size), drawing a shape, determining a current position of a cursor, registering and/or executing input events such as mouse, keyboard, and/or touchscreen events, detecting a current posture/orientation of a handheld device, etc. In some embodiments, RPA driver 25 is embodied as a set of scripts injected into browser process 32b and/or into a target document currently rendered within target window 36b.

FIG. 6-A further illustrates bridge module 34 establishing a communication channel 38 between browser processes 32a-b. In some embodiments as illustrated in FIG. 6-B, bridge module 34 is placed as an intermediary between processes 32a-b. In such embodiments, the communication channel connecting processes 32a-b is generically represented by channels 138a-b. When placed in a configuration as illustrated in FIG. 6-B, bridge module 34 may intercept, analyze, and/or alter some of the data exchanged by RPA agent 31 and RPA driver 25 before forwarding it to its intended destination. In one such example, bridge module 34 may generate a display within a separate bridge browser window 36c (e.g., a separate browser tab) according to at least some of data exchanged via communication channels 138a-b. Bridge module 34 may be embodied, for instance, as a set of content scripts executed by a distinct browser process 32c (e.g., module 34 may comprise a browser extension).

### Robot Design Embodiments

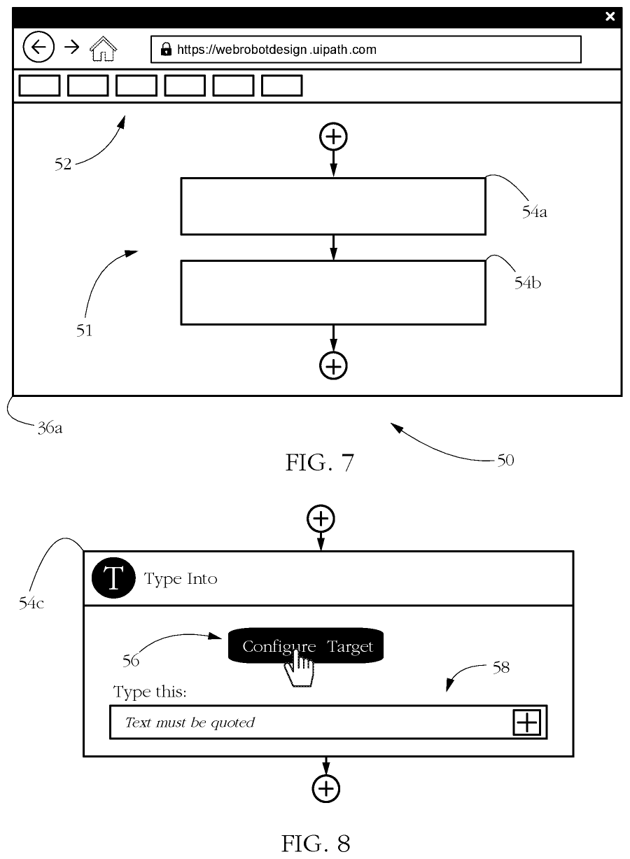

Some embodiments use browser process 32a (FIGS. 6-A-B) to load a robot design interface into agent browser window 36a. FIG. 7 illustrates an exemplary robot design interface 50 according to some embodiments of the present invention. An artisan will understand that the content and appearance of the illustrated interface are only exemplary and not meant to be limiting. Interface 50 may comprise various regions, for instance a menu region 52 and a workflow design region 51. Menu region 52 may enable a user to select individual RPA activities for execution by an RPA robot. Activities may be grouped according to various criteria, for instance, according to a type of user interaction (e.g., clicking, tapping, gestures, hotkeys), according to a type of data (e.g., text-related activities, image-related activities), according to a type of data processing (e.g., navigation, data scraping, form filling), etc. In some embodiments, individual RPA activities may be reached via a hierarchy of menus.

Workflow design region 51 may display a diagram (e.g., flowchart) of an activity sequence reproducing the flow of a business process currently being automated. The interface may expose various controls enabling the user to add, delete, and re-arrange activities of the sequence. Each RPA activity may be configured independently, by way of an activity configuration UI illustrated as items 54a-b in FIG. 7. User interfaces 54a-b may comprise children windows of interface 50. FIG. 8 shows an exemplary activity configuration interface 54c according to some embodiments of the present invention. Exemplary interface 54c configures a ‘Type Into’ activity (i.e., filling an input field of a web form) and exposes a set of fields, for instance an activity name field and a set of activity parameter fields configured to enable the user to set various parameters of the current activity. In the example of FIG. 8, parameter field 58 may receive a text to be written to the target form field. The user may provide the input text either directly, or in the form of an indicator of a source of the respective input text. Exemplary sources may include a specific cell/column/row of a spreadsheet, a current value of a pre-defined variable (for instance a value resulting from executing a previous RPA activity of the respective workflow), a document located at a specified URL, another element from the current target document, etc.

Another exemplary parameter of the current RPA activity is the operand/target of the respective activity, herein denoting the element of the target document that the RPA robot is supposed to act on. In one example wherein the selected activity comprises a mouse click, the target element may be a button, a menu item, a hyperlink, etc. In another example wherein the selected activity comprises filling out a form, the target element may be the specific form field that should receive the input. Interfaces 50, 54 may enable the user to indicate the target element in various ways. For instance, they may invite the user to select the target element from a menu/list of candidates. In a preferred embodiment, activity configuration interface 54c may instruct the user to indicate the target directly within target browser window 36b, for instance by clicking or tapping on it. Some embodiments expose a target configuration control 56 which, when activated, enables the user to further specify the target by way of a target configuration interface.

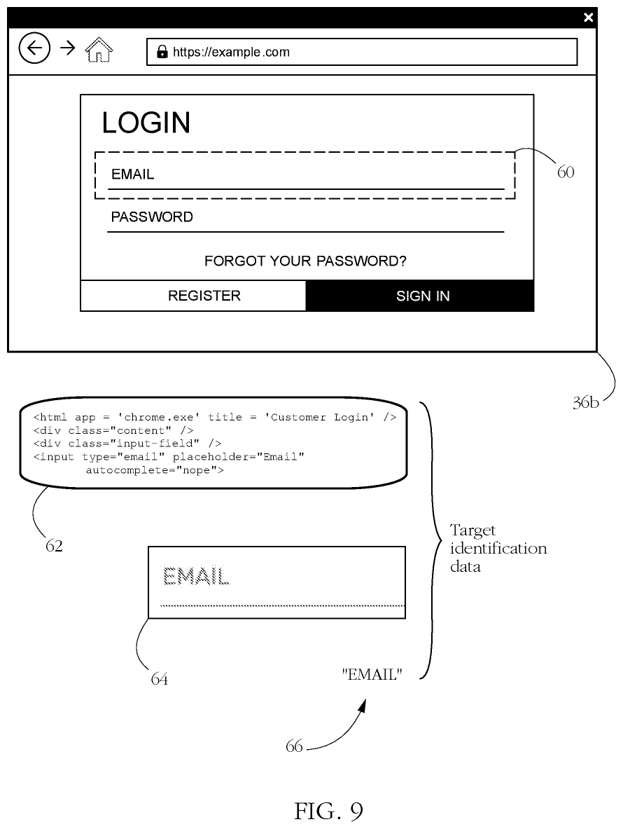

In some embodiments, RPA driver 25 is configured to analyze a user's input to determine a set of target identification data characterizing an element of the target document currently displayed within target browser window 36b, element which the user has selected as a target for the current RPA activity. FIG. 9 illustrates an exemplary target document comprising a login form displayed within target browser window 36b. FIG. 9 further shows an exemplary target UI element 60, herein the first input field of the login form. In some embodiments, target identification data characterizing target element 60 includes an element ID 62 comprising a set of data extracted from or determined according to a source-code representation of the target document. The term ‘source code’ is herein understood to denote a programmatic representation of a content displayed by the user interface. In the case of web documents, typically the source code is formulated in a version of hypertext markup language (HTML), but an artisan will know that other languages such as extensible markup languages (XML) and scripting languages such as JavaScript® may equally apply. In the example illustrated in FIG. 9, element ID 62 comprises a set of attribute-value pairs characteristic to the respective element of the target document, the set of attribute-value pairs extracted from an HTML code of the target document. In some embodiments, the set of attribute-value pairs included in element ID 62 identify the respective element as a particular node in a tree-like representation (e.g., a DOM) of the target document. For instance, the set of attribute-value pairs may indicate that the respective element is a particular input field of a particular web form forming a part of a particular region of a particular web page.

Exemplary target identification data may further comprise a target image 64 comprising an encoding of a user-facing image of the respective target element. For instance, target image 64 may comprise an array of pixel values corresponding to a limited region of a screen currently displaying target element 60, and/or a set of values computed according to the respective array of pixel values (e.g., a JPEG or wavelet representation of the respective array of pixel values). In some embodiments, target image 64 comprises a content of a clipping of a screen image located within the bounds of the respective target element.

Target identification data may further include a target text 66 comprising a computer encoding of a text (sequence of alphanumeric characters) displayed within the screen boundaries of the respective target element. Target text 66 may be determined according to the source code of the respective document and/or according to a result of applying an optical character recognition (OCR) procedure to a region of the screen currently showing target element 60.

In some embodiments, target identification data characterizing target element 60 further includes identification data (e.g., element ID, image, text, etc.) characterizing another UI element of the target webpage, herein deemed an anchor element. An anchor herein denotes any element co-displayed with the target element, i.e., simultaneously visible with the target element in at least some views of the target webpage. In some embodiments, the anchor element is selected from UI elements displayed in the vicinity of the target element, such as a label, a title, etc. For instance, in the target interface illustrated in FIG. 9, anchor candidates may include the second form field (labeled ‘Password’) and the form title (‘Login’), among others. In some embodiments, RPA driver 25 is configured to automatically select an anchor element in response to the user selecting a target of an RPA activity, as further detailed below. Including anchor-characteristic data in the specification of target element 60 may facilitate the runtime identification of the target, especially wherein identification based on characteristics of the target element alone may fail, for instance when the target webpage has multiple elements similar to the target. A web form may have multiple ‘Last Name’ fields, for instance when configured to receive information about multiple individuals. In such cases, a target identification strategy based solely on searching for a form field labelled ‘Last Name’ may run into difficulties, whereas further relying on an anchor may remove the ambiguity.

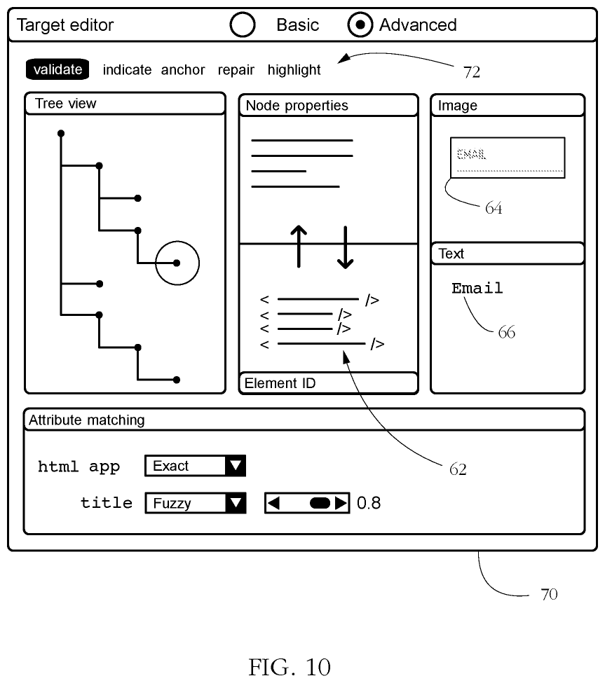

In some embodiments, activity configuration interface 54c comprises a control 56 which, when activated, triggers the display of a target configuration interface enabling the user to visualize and edit target identification data characterizing target element 60. FIG. 10 shows an example of such a target configuration interface 70, which may be displayed by RPA agent 31 within agent browser window 36a. Alternatively, interface 70 may be displayed by bridge module 34 within bridge browser window 36c. In some other exemplary embodiments, interface 70 may be displayed within target browser window 36b by driver 25 or some other software module injected into the target document. In some embodiments, to improve user experience and de-clutter the display, target configuration interface 70 may be overlayed over the current contents of the respective browser window; the overlay may be brought into focus to draw the user's attention to the current target configuration task.

In some embodiments, target configuration interface 70 comprises a menu 72 including various controls, for instance a button for indicating a target element and for editing target identification data, a button for validating a choice of target and/or a selection of target identification data, a button for selecting an anchor element associated with the currently selected target element and for editing anchor identification data, and a troubleshooting button, among others. The currently displayed view allows configuring and/or validating identification features of a target element; a similar view may be available for configuring identification features of anchor elements.

Interface 70 may be organized in various zones, for instance an area for displaying a tree representation (e.g., a DOM) of the target document, which allows the user to easily visualize target element 60 as a node in the respective tree/DOM. Target configuration interface 70 may further display element ID 62, allowing the user to visualize currently defined attribute-value pairs (e.g., HTML tags) characterizing the respective target element. Some embodiments may further include a tag builder pane enabling the user to select which tags and/or attributes to include in element ID 62.

Target configuration interface 70 may further comprise areas for displaying target image 64, target text 66, and/or an attribute matching pane enabling the user to set additional matching parameters for individual tags and/or attributes. In one example, the attribute matching pane enables the user to instruct the robot on whether to use exact or approximate matching to identify the runtime instance of target element 60. Exact matching requires that the runtime value of a selected attribute exactly match the respective design-time value included in the target identification data for the respective target element. Approximate matching may require only a partial match between the design-time and runtime values of the respective attribute. For attributes of type text, exemplary kinds of approximate matching include regular expressions, wildcard, and fuzzy matching, among others. Similar configuration fields may be exposed for matching anchor attributes.

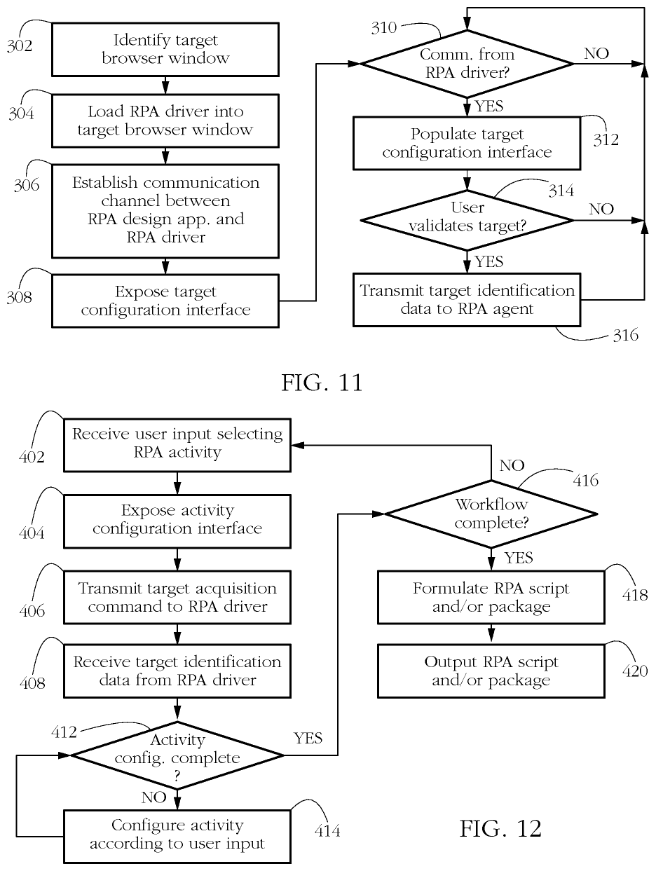

FIG. 11 shows an exemplary sequence of steps performed by bridge module 34 in some robot-design embodiments of the present invention. Without loss of generality, the illustrated sequence may apply to an embodiment as illustrated in FIG. 6-B, wherein bridge module 34 intermediates communication between RPA agent 31 and RPA driver 25, and further displays target configuration interface 70 within bridge browser window 36c. In a step 302, module 34 may identify target browser window 36b among the windows/tabs currently exposed on RPA host 20. In some embodiments, RPA agent 31 may display a menu listing all currently open browser windows/tabs and invite the user to select the one targeted for automation. An indicator of the selected window may then be passed onto module 34. In other embodiments, the user may be instructed to instantiate a new browser window/tab and then navigate to a desired target web page. In response, module 34 may identify the respective window/tab as target window 36b, and load RPA driver 25 into the respective window/tab (step 304). Alternatively, bridge module 34 may load an instance of RPA driver 25 into all currently open browser windows/tabs. In embodiments wherein bridge module 34 comprises a browser extension, step 304 comprises injecting a set of content scripts into the respective target document/webpage.

A further step 306 may set up communication channel(s) 138a-b. In an exemplary embodiment wherein browser processes 32a-b are instances of a Google Chrome® browser and wherein bridge module 34 comprises a browser extension, step 306 may comprise setting up a runtime. Port object that RPA agent 31 and driver 25 may then use to exchange data. In alternative embodiments wherein the respective browser application does not support inter-process communication, but instead allows reading and/or writing data to a local file, agent 31 and driver 25 may use the respective local file as a container for depositing and/or retrieving communications. In such embodiments, step 306 may comprise generating a file name for the respective container and communicating it to RPA agent 31 and/or driver 25. In one such example, the injected driver may be customized to include the respective filename. In some embodiments, step 306 comprises setting up distinct file containers for each browser window/tab/frame currently exposed on the respective RPA host. In yet other embodiments, agent 31 and driver 25 may exchange communications via a remote server, e.g., orchestrator 14 (FIG. 2) or a database server. In one such example, step 306 may comprise instructing the remote server to set up a container (e.g., a file or a database object) for holding data exchanged between agent 31 and driver 25 and communicating parameters of the respective container to between agent 31 and/or driver 25. Such containers may be specific to each instance of driver 25 executing on RPA host 20.

In some embodiments, bridge module 34 exposes target configuration interface 70 within to bridge browser window 36c (step 308). In a step 310, module 34 may then listen for communications from RPA driver 25; such communications may comprise target identification data as shown below. In response to such communications, a step 312 may populate interface 70 with the respective target identification data, enabling the user to review, edit, and/or validate the respective choice of target element. In some embodiments, step 312 may further comprise receiving user input comprising changes to the target identification data (e.g., adding or removing HTML, tags or attribute-value pairs to/from element ID 62, setting attribute matching parameters, etc.). When the user validates the current target identification data (a step 314 returns a YES), in a step 316 module 34 may forward the respective target identification data to RPA agent 31.

FIG. 12 shows an exemplary sequence of steps carried out by RPA agent 31 in a robot design embodiment of the present invention. In response to exposing a robot design interface within agent browser window 36a (see e.g., exemplary interface 50 in FIG. 7 and associated description above), a step 402 may receive a user input selecting an RPA activity for execution by the robot. For instance, the user may select a type of RPA activity (e.g., type into a form field) from an activity menu of interface 50. In response, a step 404 may expose an activity configuration interface such as the exemplary interface 54c illustrated in FIG. 8 (description above).

The user may then be instructed to select a target for the respective activity from the webpage displayed within target browser window 36b. In some embodiments, in a sequence of steps 406-408 RPA agent 31 may signal to RPA driver 25 to acquire target identification data, and may receive the respective data from RPA driver 25 (more details on target acquisition are given below). Such data transfers occur over the communication channel set up by bridge module 34 (e.g., channels 138a-b in FIG. 6-B). A step 414 may receive user input configuring various other parameters of the respective activity, for instance what to write to the target input field 60 in the exemplary form illustrated in FIG. 9, etc. When a user input indicates that the configuration of the current activity is complete (a step 412 returns a YES), a step 416 determines whether the current workflow is complete. When no, RPA agent 31 may return to step 402 to receive user input for configuring other RPA activities. When a user input indicates that the current workflow is complete, a sequence of steps 418-420 may formulate the RPA scripts/package specifying the respective robotic workflow and output the respective robot specification. RPA scripts 42 and/or package 40 may include, for each RPA activity of the respective workflow, an indicator of an activity type and a set of target identification data characterizing a target of the respective activity. In some embodiments, step 420 may comprise saving RPA package 40 to a computer-readable medium (e.g., local hard drive of RPA host 20) or transmitting package 40 to a remote server for distribution to executing RPA robots 12 and/or orchestrator 14.

In an alternative embodiment, instead of formulating an RPA script or package 40 for an entire robotic workflow, RPA agent 31 may formulate a specification for each individual RPA activity, complete with target identification data, and transmit the respective specification to a remote server computer, which may then assemble RPA package 40 describing the entire designed workflow from individual activity data received from RPA agent 31.

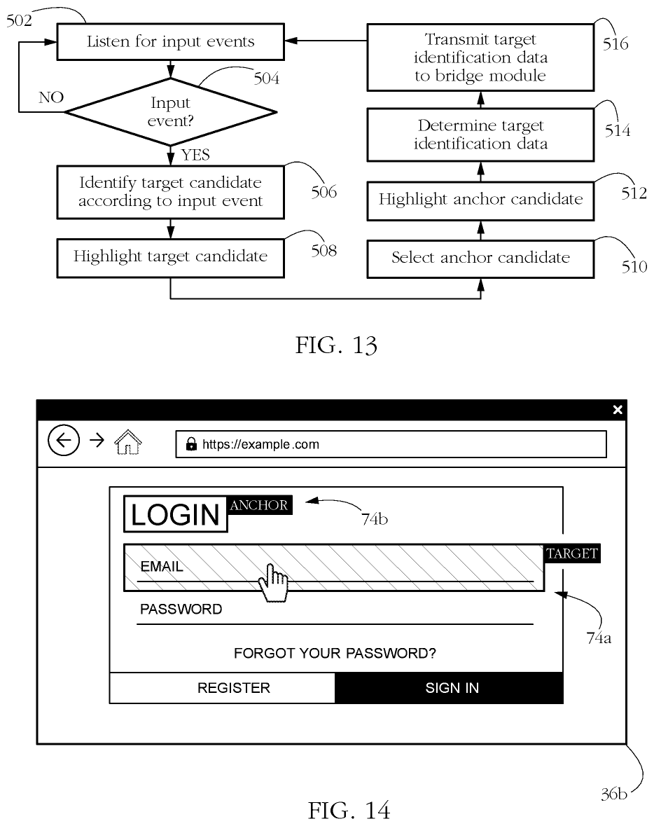

FIG. 13 shows an exemplary sequence of steps carried out by RPA driver 25 in a robot design embodiment of the present invention. Driver 25 may be configured to listen for user input events (steps 502-504), such as movements of the pointer, mouse clicks, key presses, and input gestures such as tapping, pinching, etc. In response to detecting an input event, in a step 506 driver 25 may identify a target candidate UI element according to the event. In one example wherein the detected input event comprises a mouse event (e.g., movement of the pointer), step 506 may identify an element of the target webpage located at the current position of the pointer. In another example wherein RPA host 20 does not display a pointer, for instance on a touchscreen device, step 504 may detect a screen touch, and step 506 may identify an element of the target webpage located at the position of the touch.

In some embodiments, a step 508 may highlight the target candidate element identified in step 508. Highlighting herein denotes changing an appearance of the respective target candidate element to indicate it as a potential target for the current RPA activity. FIG. 14 illustrates exemplary highlighting according to some embodiments of the present invention. Step 508 may comprise changing the specification (e.g., HTML, DOM) of the target document to alter the look of the identified target candidate (e.g., font, size, color, etc.), or to create a new highlight element, such as exemplary highlights 74a-b shown in FIG. 14. Exemplary highlight elements may include a polygonal frame surrounding the target candidate, which may be colored, shaded, hatched, etc., to make the target candidate stand out among other elements of the target webpage. Other exemplary highlight elements may include text elements, icons, arrows, etc.

In some embodiments, identifying a target candidate automatically triggers selection of an anchor element. The anchor may be selected according to a type, position, orientation, and a size of the target candidate, among others. For instance, some embodiments select as anchors elements located in the immediate vicinity of the target candidate, preferably aligned with it. Step 510 (FIG. 13) may apply any anchor selection criterion known in the art; such criteria and algorithms go beyond the scope of the present description. In a further step 512, driver 25 may highlight the selected target element by changing its screen appearance as described above. Some embodiments use distinct highlights for the target and anchor elements (e.g., different colors, different hatch types, etc.) and may add explanatory text as illustrated. In some embodiments, steps 510-512 are repeated multiple times to select multiple anchors for each target candidate.

In a step 514, RPA driver 25 may determine target identification data characterizing the candidate target and/or the selected anchor element. To determine element ID 62, some embodiments may parse a live DOM of the target webpage, extracting and/or formulating a set of HTML tags and/or attribute-value pairs characterizing the candidate target element and/or anchor element. Step 514 may further include taking a snapshot of a region of the screen currently showing the candidate target and/or anchor elements to determine image data (e.g., target image 64 in FIGS. 9-10). A text/label displayed by the target and/or anchor elements may be extracted by parsing the source code and/or by OCR procedures. In a step 516, driver 25 may transmit the target identification data determined in step 514 to bridge module 34 and/or to RPA agent 31. Such communications are carried out via channels (e.g., 138a-b in FIG. 6-B) established by bridge module 34.

The exemplary flowchart in FIG. 13 assumes RPA driver 25 is listening to user events occurring within its own browser window (e.g., input events), taking its own decisions, and automatically transmitting element identification data to bridge module 34 and/or agent 31. In an alternative embodiment, RPA agent 31 and/or bridge module 34 may actively request data from RPA driver 25 by way of commands or other kinds of communications transmitted via channels 38 or 138a-b. Meanwhile, RPA driver 25 may merely execute the respective commands. For instance, agent 31 may request driver 25 to acquire a target, then to acquire an anchor. Such requests may be issued for instance in embodiments wherein the user is expected to manually select an anchor, in contrast to the description above wherein anchors are selected automatically in response to identification of a candidate target. In turn, driver 25 may only return element identification data upon request. In yet other alternative embodiments, the algorithm for automatically selecting an anchor element may be executed by RPA agent 31 and not by driver 25 as described above. For instance, agent 31 may send a request to driver 25 to identify a UI element located immediately to the left of the target, and assign the respective element as anchor. An artisan will know that such variations are given as examples and are not meant to narrow the scope of the invention.

The description above refers to an exemplary embodiment wherein bridge module 34 intermediates communication between RPA agent 31 and driver 25 (see e.g., FIG. 6-B), and wherein module 34 displays a target configuration interface (e.g., interface 70 in FIG. 10) within bridge browser window 36c. In another exemplary embodiment, bridge module 34 only sets up a direct communication channel between driver 25 and agent 31 (e.g., as in FIG. 6-A), while RPA agent 31 displays a target configuration interface within agent browser window 36a. In such embodiments, RPA driver 25 may receive target acquisition commands from agent 31 and may return target identification data directly to agent 31.

The description above also focused on a version of robot design wherein the user selects from a set of activities available for execution, and then proceeds to configure each individual activity by indicating a target and other parameters. Other exemplary embodiments may implement another popular robot design scenario, wherein the robot design tools record a sequence of user actions (such as the respective user's navigating through a complex target website) and configure a robot to reproduce the respective sequence. In some such embodiments, for each user action such as a click, scroll, type in, etc., driver 25 may be configured to determine a target of the respective action including a set of target identification data, and to transmit the respective data together with an indicator of a type of user action to RPA agent 31 via communication channel 38 or 138a-b. RPA agent 31 may then assemble a robot specification from the respective data received from RPA driver 25.

### Robot Execution Embodiments

In contrast to the exemplary embodiments illustrated above, which were directed at designing an RPA robot to perform a desired workflow, in other embodiments of the present invention RPA agent 31 comprises at least a part of RPA robot 12 configured to actually carry out an automation. For instance, RPA agent 31 may embody some of the functionality of robot manager 24 and/or robot executors 22 (see FIG. 2 and associated description above).

In one exemplary robot execution embodiment, the user may use agent browser window 36a to open a robot specification. The specification may instruct a robot to navigate to a target web page and perform some activity, such as filling in a form, scraping some text or images, etc. For example, an RPA package 40 may be downloaded from a remote ‘robot store’ by accessing a specific URL or selecting a menu item from a web interface exposed by a remote server computer. Package 40 may include a set of RPA scripts 42 formulated in a computer-readable form that enables scripts 42 to be executed by a browser process. For instance, scripts 42 may be formulated in a version of JavaScript®. Scripts 42 may comprise a specification of a sequence of RPA activities (e.g., navigating to a webpage, clicking on a button, etc.), including a set of target identification data characterizing a target/operand of each RPA activity (e.g., which button to click, which form field to fill in, etc.).

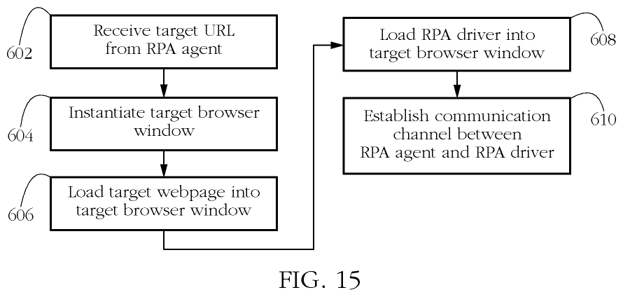

FIG. 15 shows an exemplary sequence of steps performed by bridge module 34 in a robot execution embodiment of the present invention. In a step 602, module 34 may receive a URL of the target webpage from RPA agent 31, which in turn may have received it as part of RPA package 40. A sequence of steps 604-606 may then instantiate target browser window 36b (e.g., open a new browser tab) and load the target webpage into the newly instantiated window. Step 604 may further comprise launching a separate browser process to render the target webpage within target browser window 36b. In an alternative embodiment, agent 31 may instruct the user to open target browser window 36b and navigate to the target webpage.

In a further sequence of steps 608-610, module 34 may inject RPA driver 25 into the target webpage/browser window 36b and set up a communication channel between RPA agent 31 and driver 25 (see e.g., channel 38 in FIG. 6-A). For details, please see description above in relation to FIG. 11.

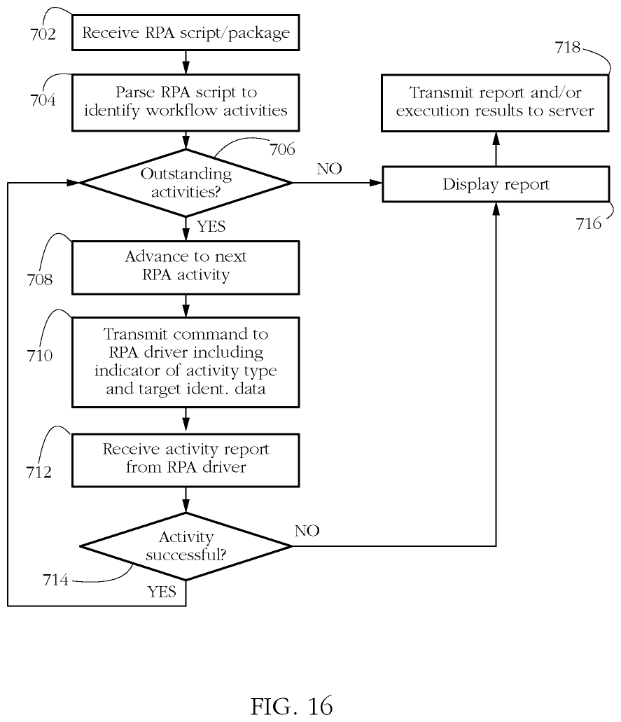

FIG. 16 shows an exemplary sequence of steps carried out by RPA agent 31 in a robot execution embodiment of the present invention. In response to receiving RPA package 40 in a step 702, in a step 704 agent 31 may parse the respective specification to identify activities to be executed. Then, a sequence of steps 706-708 may cycle through all activities of the respective workflow. For each activity, a step 710 may transmit an execution command to RPA driver 25 via channel 38, the command comprising an indicator of a type of activity and further comprising target identification data characterizing a target/operand of the respective activity. Some embodiments may then receive an activity report from RPA driver 25 via the communication channel, wherein the report may indicate for instance whether the respective activity was successful and may further comprise a result of executing the respective activity. In some embodiments, a step 714 may determine according to the received activity report whether the current activity was executed successfully, and when no, a step 716 may display a warning to the user within agent browser window 36a. In response to completing the automation (e.g., step 706 determined that there are no outstanding activities left to execute), step 716 may display a success message and/or results of executing the respective workflow to the user. In some embodiments, a further step 718 may transmit a status report comprising results of executing the respective automation to a remote server (e.g., orchestrator 14). Said results may include, for instance, data scraped from the target webpage, an acknowledgement displayed by the target webpage in response to successfully entering data into a webform, etc.

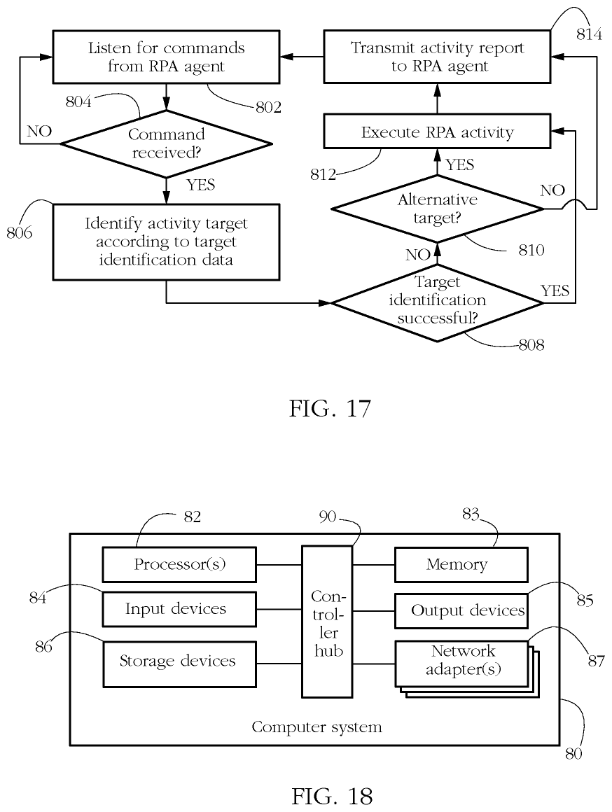

FIG. 17 shows an exemplary sequence of steps carried out by RPA driver 25 in a robot execution embodiment of the present invention. Driver 25 may be configured to listen for execution commands from RPA agent over communication channel 38 (steps 802-804). In response to receiving a command, a step 806 may attempt to identify the target of the current activity according to target identification data received from RPA agent 31. Step 806 may comprise searching the target webpage for an element matching the respective target identification data. For instance, RPA driver 25 may parse a live DOM of the target webpage to identify an element whose HTML tags and/or other attribute-value pairs match those specified in element ID 62. In some embodiments, when identification according to element ID 62 fails, RPA driver 25 may attempt to find the runtime target according to image and/or text data (e.g., element image 64 and element text 66 in FIG. 9. Some embodiments may further attempt to identify the runtime target according to identification data characterizing an anchor element and/or according to a relative position and alignment of the runtime target with respect to the anchor. Such procedures and algorithms go beyond the scope of the current description.

When target identification is successful (a step 808 returns a YES), a step 812 may execute the current RPA activity, for instance click on the identified button, fill in the identified form field, etc. Step 812 may comprise manipulating a source code of the target web page and/or generating an input event (e.g., a click, a tap, etc.) to reproduce a result of a human operator actually carrying out the respective action.

When the runtime target of the current activity cannot be identified according to target identification data received from RPA agent 31 (for instance in situations wherein the target webpage has changed substantially between design time and runtime), some embodiments transmit an error message/report to RPA agent 31 via communication channel 38. In an alternative embodiment, RPA driver 25 may search for an alternative target. In one such example, driver 25 may identify an element of the target webpage approximately matching the provided target identification data. Some embodiments identify multiple target candidates partially matching the desired target characteristics and compute a similarity measure between each candidate and the design-time target. An alternative target may then be selected by ranking the target candidates according to the computed similarity measure. In response to selecting an alternative runtime target, some embodiments of driver 25 may highlight the respective UI element, for instance as described above in relation to FIG. 14, and request the user to confirm the selection. In yet another exemplary embodiment, driver 25 may display a dialog indicating that the runtime target could not be found and instructing the user to manually select an alternative target. Driver 25 may then wait for user input. Once the user has selected an alternative target (e.g., by clicking, tapping, etc., on a UI element), RPA driver 25 may identify the respective element within the source code and/or DOM of the target webpage using methods described above in relation to FIG. 13 (step 506). When an alternative runtime target is available (a step 810 returns a YES), driver 25 may apply the current activity to the alternative target (step 812).

When for any reason driver 25 cannot identify any alternative target, in some embodiments a step 814 returns an activity report to RPA agent 31 indicating that the current activity could not be executed because of a failure to identify the runtime target. In some embodiments, the activity report may further identify a subset of the target identification data that could not be matched in any element of the target webpage. Such reporting may facilitate debugging. When the current activity was successfully executed, the report sent to RPA agent 31 may comprise a result of executing the respective activity. In an alternative embodiment, step 814 may comprise sending the activity report and/or a result of executing the respective activity to a remote server computer (e.g., orchestrator 14) instead of the local RPA agent.

FIG. 18 illustrates an exemplary hardware configuration of a computer system 80 programmable to carry out some of the methods and algorithms described herein. The illustrated configuration is generic and may represent for instance any RPA host 20a-e in FIG. 4. An artisan will know that the hardware configuration of some devices (e.g., mobile telephones, tablet computers, server computers) may differ somewhat from the one illustrated in FIG. 18.

The illustrated computer system comprises a set of physical devices, including a hardware processor 82 and a memory unit 84. Processor 82 comprises a physical device (e.g. a microprocessor, a multi-core integrated circuit formed on a semiconductor substrate, etc.) configured to execute computational and/or logical operations with a set of signals and/or data. In some embodiments, such operations are delivered to processor 82 in the form of a sequence of processor instructions (e.g. machine code or other type of encoding). Memory unit 84 may comprise volatile computer-readable media (e.g. DRAM, SRAM) storing instructions and/or data accessed or generated by processor 82.

Input devices 86 may include computer keyboards, mice, and microphones, among others, including the respective hardware interfaces and/or adapters allowing a user to introduce data and/or instructions into the respective computer system. Output devices 88 may include display devices such as monitors and speakers among others, as well as hardware interfaces/adapters such as graphic cards, allowing the illustrated computing appliance to communicate data to a user. In some embodiments, input devices 86 and output devices 88 share a common piece of hardware, as in the case of touch-screen devices. Storage devices 92 include computer-readable media enabling the non-volatile storage, reading, and writing of software instructions and/or data. Exemplary storage devices 92 include magnetic and optical disks and flash memory devices, as well as removable media such as CD and/or DVD disks and drives. The set of network adapters 94, together with associated communication interface(s), enables the illustrated computer system to connect to a computer network (e.g., network 13 in FIG. 4) and/or to other devices/computer systems. Controller hub 90 generically represents the plurality of system, peripheral, and/or chipset buses, and/or all other circuitry enabling the communication between processor 82 and devices 84, 86, 88, 92, and 94. For instance, controller hub 90 may include a memory controller, an input/output (I/O) controller, and an interrupt controller, among others. In another example, controller hub 90 may comprise a northbridge connecting processor 82 to memory 84, and/or a southbridge connecting processor 82 to devices 86, 88, 92, and 94.

The exemplary systems and methods described above facilitate the uptake of RPA technologies by enabling RPA software to execute on virtually any host computer, irrespective of its hardware type and operating system. As opposed to conventional RPA software, which is typically distributed as a separate self-contained software application, in some embodiments of the present invention RPA software comprises a set of scripts that execute within a web browser such as Google Chrome®, among others. Said scripts may be formulated in a scripting language such as JavaScript® or some version of bytecode which browsers are capable of interpreting.

Whereas in conventional RPA separate versions of the software must be developed for each hardware platform (i.e., processor family) and/or each operating system (e.g., Microsoft Windows® vs. Linux®), some embodiments of the present invention allow the same set of scripts to be used on any platform and operating system which can execute a web browser with script interpretation functionality. On the software developer's side, removing the need to build and maintain multiple versions of a robot design application may substantially facilitate software development and reduce time-to-market. Client-side advantages include a reduction in administration costs by removing the need to purchase, install, and upgrade multiple versions of RPA software, and further simplifying the licensing process. Individual RPA developers may also benefit by being able to design, test, and run automations from their own computers, irrespective of operating system.

However, performing RPA from inside of a browser presents substantial technical challenges. RPA software libraries may be relatively large, so inserting them into a target web document may be impractical and may occasionally cause the respective browser process to crash or slow down. Instead, some embodiments of the present invention break up the functionality of RPA software into several parts, each part executing within a separate browser process, window, or tab. For instance, in a robot design embodiment, a design interface may execute within one browser window/tab, distinct from another window/tab displaying the webpage targeted for automation. Some embodiments then only inject a relatively small software component (e.g., an RPA driver as disclosed above) into the target web page, the respective component configured to execute basic tasks such as identifying UI elements and mimicking user actions such as mouse clicks, finger taps, etc. By keeping the bulk of RPA software outside of the target document, some embodiments improve user experience, stability, and performance of RPA software.

Another advantage of having distinct RPA components in separate windows/tabs is enhanced functionality. Since modern browsers typically keep distinct windows/tabs isolated from each other for computer security and privacy reasons, an RPA system wherein all RPA software executes within the target web page may only have access to the contents of the respective window/tab. In an exemplary situation wherein clicking a hyperlink triggers the display of an additional webpage within a new window/tab, the contents of the additional webpage may therefore be off limits to the RPA software. In contrast to such RPA strategies, some embodiments of the present invention are capable of executing interconnected snippets of RPA code in multiple windows/tabs at once, thus eliminating the inconvenience. In one exemplary embodiment, the RPA driver executing within the target webpage detects an activation of a hyperlink and communicates the fact to the bridge module. In response, the bridge module may detect an instantiation of a new browser window/tab, automatically inject another instance of the RPA driver into the newly opened window/tab, and establish a communication channel between the new instance of the RPA driver and the RPA agent executing within the agent browser window, thus enabling a seamless automation across multiple windows/tabs.

Furthermore, a single instance of the RPA agent may manage automation of multiple windows/tabs. In a robot design embodiment, the RPA agent may collect target identification data from multiple instances of the RPA driver operating in distinct browser windows/tabs, thus capturing the details of the user's navigation across multiple pages and hyperlinks. In a robot execution embodiment, the RPA agent may transmit window-specific target identification data to each instance of the RPA agent, thus enabling the robot to reproduce complex interactions with multiple web pages, for instance scraping and combining data from multiple sources.

Meanwhile, keeping distinct RPA components in distinct windows/tabs creates extra technical problems by explicitly going against the browser's code isolation policy. To overcome such hurdles, some embodiments set up a communication channel between the various RPA components to allow exchange of messages, such as target identification data and status reports. One exemplary embodiment uses a browser extension mechanism to set up such communication channels.

It will be clear to one skilled in the art that the above embodiments may be altered in many ways without departing from the scope of the invention. Accordingly, the scope of the invention should be determined by the following claims and their legal equivalents.

What is claimed is:

1. A method comprising employing at least one hardware processor of a computer system to execute a first web browser process, a second web browser process, and a bridge module, wherein:
the bridge module is configured to set up a communication channel between the first web browser process and the second web browser process;
the first web browser process exposes to a user a first web browser window, and is further configured to:
receive a specification of a robotic process automation (RPA) workflow from a remote server computer,
select an RPA activity for execution from the RPA workflow, the RPA activity comprising mimicking an action of the user on a target element of a target web page displayed within a second browser window, and
transmit a set of target identification data characterizing the target element via the communication channel; and
the second web browser process executes an RPA driver configured to:
receive the set of target identification data via the communication channel,
in response, identify the target element within the target web page according to the target identification data, and
carry out the RPA activity.

2. The method of claim 1, wherein the bridge module is further configured to inject the RPA driver into the target web page.

3. The method of claim 1, wherein the bridge module is further configured to:
detect an instantiation of a new browser window;
in response, inject another instance of the RPA driver into a document displayed within the new browser window; and
set up another communication channel between the first web browser process and another web browser process displaying the document.

4. The method of claim 3, wherein the other instance of the RPA driver is configured to:
receive another set of target identification data via the other communication channel, the other set of target identification data characterizing an element of the document;
in response, identify the element of the document according to the other target identification data; and
carry out another RPA activity of the RPA workflow on the element of the document.

5. The method of claim 1, wherein:
the RPA driver is further configured to transmit a result of carrying out the RPA activity to the first browser process via the communication channel; and
the first browser process is further configured to generate a display according to the result within the first browser window.

6. The method of claim 5, wherein the result of carrying out the RPA activity comprises data extracted from the target webpage.

7. The method of claim 1, wherein the RPA driver is further configured to transmit a result of carrying out the RPA activity to the remote server computer.

8. The method of claim 1, wherein the RPA driver is further configured, in response to a failure to identify the target element, to automatically select an alternative target element within the target web page.

9. The method of claim 8, wherein the RPA driver is further configured, in response to selecting an alternative target element, to change an appearance of the alternative target element to highlight the alternative target element with respect to other elements of the target web page.

10. The method of claim 1, wherein the RPA driver is further configured, in response to a failure to identify the target element, to:
receive a user input indicating an alternative target element of the target web page; and
in response, carry out the RPA activity on the alternative target element.

11. The method of claim 1, wherein the RPA driver is further configured, in response to a failure to identify the target element, to transmit an activity report to the first browser process via the communication channel, the activity report identifying a subset of the target identification data that could not be matched to any element of the target webpage.

12. A computer system comprising at least one hardware processor configured to execute a first web browser process, a second web browser process, and a bridge module, wherein:
the bridge module is configured to set up a communication channel between the first web browser process and the second web browser process;
the first web browser process exposes to a user a first web browser window, and is further configured to:
receive a specification of an RPA workflow from a remote server computer,
select an RPA activity for execution from the RPA workflow, the RPA activity comprising mimicking an action of the user on a target element of a target web page displayed within a second browser window, and
transmit a set of target identification data characterizing the target element via the communication channel; and
the second web browser process executes an RPA driver configured to:
receive the set of target identification data via the communication channel,
in response, identify the target element within the target web page according to the target identification data, and
carry out the RPA activity.

13. The computer system of claim 12, wherein the bridge module is further configured to inject the RPA driver into the target web page.

14. The computer system of claim 12, wherein the bridge module is further configured to:
detect an instantiation of a new browser window;
in response, inject another instance of the RPA driver into a document displayed within the new browser window; and
set up another communication channel between the first web browser process and another web browser process displaying the document.

15. The computer system of claim 14, wherein the other instance of the RPA driver is configured to:
receive another set of target identification data via the other communication channel, the other set of target identification data characterizing an element of the document;
in response, identify the element of the document according to the other target identification data; and
carry out another RPA activity of the RPA workflow on the element of the document.

16. The computer system of claim 12, wherein:
the RPA driver is further configured to transmit a result of carrying out the RPA activity to the first browser process via the communication channel; and
the first browser process is further configured to generate a display according to the result within the first browser window.

17. The computer system of claim 16, wherein the result of carrying out the RPA activity comprises data extracted from the target webpage.

18. The computer system of claim 12, wherein the RPA driver is further configured to transmit a result of carrying out the RPA activity to the remote server computer.

19. The computer system of claim 12, wherein the RPA driver is further configured, in response to a failure to identify the target element, to automatically select an alternative target element within the target web page.

20. The computer system of claim 19, wherein the RPA driver is further configured, in response to selecting an alternative target element, to change an appearance of the alternative target element to highlight the alternative target element with respect to other elements of the target web page.

21. The computer system of claim 12, wherein the RPA driver is further configured, in response to a failure to identify the target element, to:
receive a user input indicating an alternative target element of the target web page; and
in response, carry out the RPA activity on the alternative target element.

22. The computer system of claim 12, wherein the RPA driver is further configured, in response to a failure to identify the target element, to transmit an activity report to the first browser process via the communication channel, the activity report identifying a subset of the target identification data that could not be matched to any element of the target webpage.

23. A non-transitory computer-readable medium storing instructions which, when executed by at least one hardware processor of a computer system, cause the computer system to form a bridge module configured to set up a communication channel between a first web browser process and a second web browser process, wherein the first and second web browser processes execute on the computer system, and wherein:
the first web browser process exposes to a user a first web browser window, and is further configured to:
receive a specification of an RPA workflow from a remote server computer,
select an RPA activity for execution from the RPA workflow, the RPA activity comprising mimicking an action of the user on a target element of a target web page displayed within a second browser window, and
transmit a set of target identification data characterizing the target element via the communication channel; and
the second web browser process executes an RPA driver configured to:
receive the set of target identification data via the communication channel,
in response, identify the target element within the target web page according to the target identification data, and
carry out the RPA activity.
